(19) United States
(12) Patent Application Publication
(10) Pub. No.: US 2026/0350904 A1
(43) Pub. Date: Nov. 5, 2026

(54) METHOD, APPARATUS, DEVICE, READABLE STORAGE MEDIUM AND PRODUCT FOR PROCESSING LIVE STREAMING IMAGE FRAME

(71) Applicant: Beijing Zitiao Network Technology Co., Ltd., Haidian District, Beijing (CN)

(72) Inventors: Yongzhan Chen, Beijing (CN); Linjun Jiang, Beijing (CN); Jiajia Luo, Beijing (CN); Jiawei Li, Beijing (CN); Siying Chen, Beijing (CN)

(21) Appl. No.: 19/139,781

(22) PCT Filed: Dec. 1, 2023
(86) PCT No.: PCT/CN2023/135962

§ 371 Date: Jun. 16, 2025

(30) Foreign Application Priority Data
Dec. 15, 2022 (CN) 202211612879.6

(51) Int. Cl. G06T 15/04; G06T 5/20; G06T 5/70; G06T 5/77; G06T 7/00; G06V 40/16

(52) U.S. Cl. CPC G06T 15/04; G06T 5/20; G06T 5/70; G06T 5/77; G06T 7/0002; G06V 40/161; G06T 2207/10024; G06T 2207/20028; G06T 2207/30201

(57) ABSTRACT

There provides a method, an apparatus, a device, a readable storage medium and a product for processing a live streaming image frame. The method includes: obtaining an image frame processing request; obtaining, based on the image frame processing request, a live streaming image frame corresponding to a virtual reality live streaming content; determining a region to be processed in the live streaming image frame, and performing a first processing operation on the region to be processed to obtain an image frame to be processed; performing a global second processing operation on the image frame to be processed to obtain a processed target image frame; displaying the target image frame. Therefore, the image frame can be processed in the VR scene. It is possible to effectively reduce the computation in the image processing process, improve the efficiency of image beautification operations, and ensure high-quality live streaming effects.

This application claims the priority to Chinese Patent Application No. 202211612879.6, filed on Dec. 15, 2022, and entitled “METHOD, APPARATUS, DEVICE, READABLE STORAGE MEDIUM AND PRODUCT FOR PROCESSING LIVE STREAMING IMAGE FRAME”, the entirety of which is incorporated herein by reference.

### FIELD

The embodiment of the disclosure relates to the technical field of image processing, in particular to a method, an apparatus, a device, a readable storage medium and product for processing a live streaming image frame.

### BACKGROUND

In a live streaming process, in order to obtain a better live streaming effect, an optimization operation of live streaming content may be performed by using a beauty technology according to a trigger of a user. The existing beauty technology may be applied to the PC terminal and the mobile terminal to realize the beauty operation in the 2D scene.

With the development of science and technology, virtual reality (VR) technology gradually enters into the life of a user. The user can realize the VR live streaming of 3D through the VR technology. However, the existing beauty technology cannot achieve beauty operation in VR scenes.

### SUMMARY

The embodiment of the disclosure provides a method, an apparatus, a device, a readable storage medium and a product for processing a live streaming image frame, for solving the technical problem that an existing beauty technology cannot realize image optimization operation in a VR scene.

In a first aspect, an embodiment of the disclosure provides a method of processing a live streaming image frame, comprising:
obtaining an image frame processing request;
obtaining, based on the image frame processing request, a live streaming image frame corresponding to a virtual reality live streaming content;
determining a region to be processed in the live streaming image frame, and performing a first processing operation on the region to be processed to obtain an image frame to be processed;
performing a global second processing operation on the image frame to be processed to obtain a processed target image frame;
displaying the target image frame.

In a second aspect, an embodiment of the disclosure provides a system for processing a live streaming image frame, comprising: a terminal device, a binocular image capture device and a virtual reality device; wherein,
the binocular image capture device is configured to capture a live streaming image frame corresponding to a virtual reality live streaming content;
the terminal device is configured to obtain an image frame processing request, and obtain, based on the image frame processing request, a live streaming image frame corresponding to a virtual reality live streaming content; determine a region to be processed in the live streaming image frame, and perform a first processing operation on the region to be processed to obtain an image frame to be processed; perform a global second processing operation on the image frame to be processed to obtain a processed target image frame; and send the target image frame to the virtual reality device;
the virtual reality device is configured to display the target image frame.

In a third aspect, an embodiment of the disclosure provides an apparatus for processing a live streaming image frame, comprising:

an obtaining module, configured to obtain an image frame processing request;
an image frame obtaining module, configured to obtain, based on the image frame processing request, a live streaming image frame corresponding to a virtual reality live streaming content;
a determining module, configured to determine a region to be processed in the live streaming image frame, and perform a first processing operation on the region to be processed to obtain an image frame to be processed; and
a processing module, configured to perform a global second processing operation on the image frame to be processed to obtain a processed target image frame;
a sending module, configured to display the target image frame.

In a fourth aspect, an embodiment of the disclosure provides an electronic device, comprising: a processor and a memory;
the memory storing computer executable instructions;
the processor executing the computer-executable instructions stored in the memory, to cause the processor to implement a method of processing a live streaming image frame according to the above first aspect and various possible designs thereof.

In a fifth aspect, an embodiment of the disclosure provides a computer-readable storage medium, the computer-readable storage medium storing computer-executable instructions which, when executed by a processor, implements a method of processing a live streaming image frame according to the above first aspect and various possible designs thereof.

In a sixth aspect, an embodiment of the disclosure provides a computer program product, comprising a computer program, the computer program, when executed by a processor, implements a method of displaying information according to the above first aspect and various possible designs thereof.

According to the method, apparatus, device, readable storage medium and the product for processing a live streaming image frame provided by the embodiment, a live streaming image frame corresponding to a virtual reality live streaming content is obtained based on the image frame processing request. A first processing operation is performed on a region to be processed in the live streaming image frame, and a global second processing operation is performed on the image frame to be processed after the first processing operation. The target image frame after the second processing operation is sent to the predetermined terminal device for display. Therefore, the image frame can be processed in the VR scene. In addition, by performing the first processing operation on the region to be processed and the second processing operation globally, it is possible to effectively reduce the computation in the image processing process, improve the efficiency of image beautification operations, and ensure high-quality live streaming effects.

### BRIEF DESCRIPTION OF DRAWINGS

In order to more clearly illustrate the embodiments of the disclosure or the technical solutions in the prior art, the accompanying drawings used in the description of the embodiments or the prior art will be briefly introduced below, and it will be apparent that the drawings in the following description are some embodiments of the disclosure, and those skilled in the art may also obtain other drawings according to these drawings without creative labor.

FIG. 1 is a schematic structural diagram of a system for processing a live streaming image frame according to an embodiment of the disclosure;

FIG. 2 is a schematic flowchart of a method of processing a live streaming image frame according to an embodiment of the disclosure;

FIG. 3 is a schematic flowchart of a method of processing a live streaming image frame according to another embodiment of the disclosure;

FIG. 4 is a schematic flowchart of a method of processing a live streaming image frame according to still another embodiment of the disclosure;

FIG. 5 is a schematic flowchart of a method of processing a live streaming image frame according to still another embodiment of the disclosure;

FIG. 6 is a schematic diagram of interface interaction according to an embodiment of the disclosure;

FIG. 7 is a schematic structural diagram of an apparatus for processing a live streaming image frame according to an embodiment of the disclosure;

FIG. 8 is a schematic structural diagram of an electronic device according to an embodiment of the disclosure.

### DETAILED DESCRIPTION

In order to make the objectives, technical solutions and advantages of the embodiments of the disclosure clearer, the technical solutions in the embodiments of the disclosure will be clearly and completely described below with reference to the accompanying drawings in the embodiments of the disclosure. All other embodiments obtained by those skilled in the art based on the embodiments of the disclosure without creative efforts shall fall within the scope of the disclosure.

In order to solve the technical problem that an image optimization operation in a VR scene cannot be implemented in the prior art, the disclosure provides a method, an apparatus, a device, a readable storage medium, and a product for processing a live streaming image frame.

It should be noted that the method, the apparatus, the device, the readable storage medium, and the product for processing a live streaming image frame provided in the disclosure may be applied to any scenario in which any live streaming image frame is beautified.

The existing beauty technology is generally applied to a 2D scene, but cannot implement beautification operation on a live streaming image frame in a VR scene.

In the process of solving the above technical problem, the inventor finds through research that a system for processing a live streaming image frame comprising a terminal device, a binocular image capture device, and a virtual reality device may be constructed. Based on the above system for processing a live streaming image frame, the binocular image capture device simultaneously captures real-time image data (single image of 4K) of the streamer from different perspectives, and presses the two images into an input image of 8K. Second, the input 8k image is inputted into the terminal device for face recognition and rendering process, where the terminal device may be specifically a personal computer (PC) host. The processed video image is then pushed to the virtual reality device. Finally, the display client of the virtual reality device receives the live streaming video stream and plays the 3D video, then the user can watch the 3D live streaming after beauty processing.

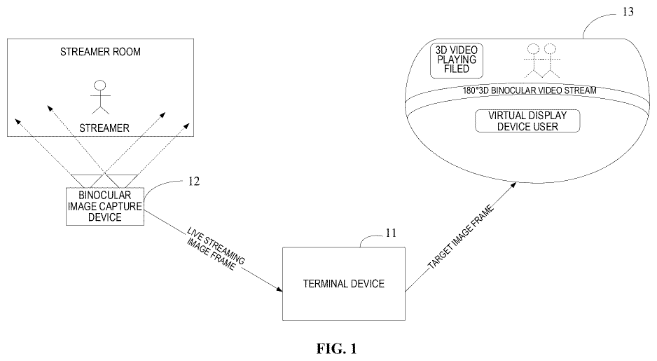

FIG. 1 is a schematic structural diagram of a system for processing a live streaming image frame according to an embodiment of the disclosure. As shown in FIG. 1, the system for processing a live streaming image frame may comprise a terminal device 11, a binocular image capture device 12, and a virtual reality device 13. The terminal device 11 is in communication connection with the binocular image capture device 12 and the virtual reality device 13, respectively, so as to be capable of information interaction with the binocular image capture device 12 and the virtual reality device 13, respectively.

Based on the foregoing system architecture, the binocular image capture device 12 is configured to capture a live streaming image frame corresponding to a virtual reality live streaming content;

The terminal device 11 is configured to obtain an image frame processing request, and obtain, based on the image frame processing request, a live streaming image frame corresponding to a virtual reality live streaming content; determine a region to be processed in the live streaming image frame, and perform a first processing operation on the region to be processed to obtain an image frame to be processed; perform a second processing operation on the image frame to be processed to obtain a processed target image frame; and send the target image frame to the virtual reality device 13;
the virtual reality device 13 is configured to display the target image frame.

Based on the foregoing system architecture, the beautification operation of the live streaming image frame in the 3D scene can be implemented, thereby enabling the user to watch the 3D live streaming after beauty processing in the virtual reality device.

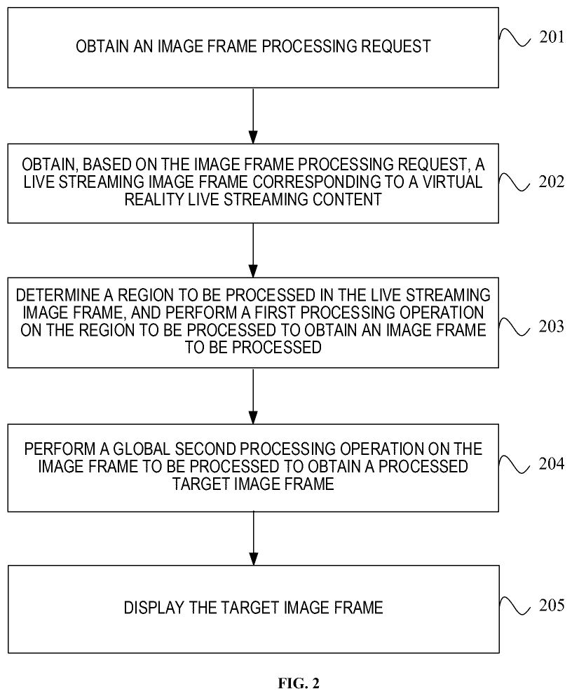

FIG. 2 is a schematic flowchart of a method of processing a live streaming image frame according to an embodiment of the disclosure. As shown in FIG. 2, the method comprises:

Step 201: obtaining an image frame processing request.

The execution body of this embodiment is a terminal device, and the terminal device may be in communication connection with the binocular image capture device and the virtual reality device, so as to perform information interaction with the binocular image capture device and the virtual reality device communication connection. Optionally, the terminal device may be specifically a PC host. Alternatively, the terminal device may be any device capable of processing image, which is not limited in the disclosure.

Optionally, the terminal device may further be communicatively connected to a device with which the user performs live streaming. When users perform live streaming in VR, they can choose beauty technology to beautify the live streaming content according to their actual needs. Correspondingly, when the user triggers the beauty option on the terminal device, an image frame processing request may be generated based on the trigger, and the image frame processing request may be sent to the terminal device.

As a possible implementation, the live streaming content may also be automatically beautified when the user triggers the live streaming operation. The image frame processing request may be automatically generated when a starting operation is received from the user, and then the image frame processing request is sent to the terminal device.

Correspondingly, the terminal device may obtain the image frame processing request.

Step 202: obtaining, based on the image frame processing request, a live streaming image frame corresponding to a virtual reality live streaming content.

In this embodiment, when the image frame processing request is obtained, the live streaming image frame corresponding to the virtual reality live streaming content may be obtained.

In a VR live streaming scenario, a binocular image capture device is generally used to capture live streaming content. The binocular image capture device obtains real-time images of a streamer from different perspectives, and an output image size of each camera is 4k. Therefore, the live streaming image frame corresponding to the virtual reality live streaming content may be specifically obtained.

Step 203: determining a region to be processed in the live streaming image frame, and performing a first processing operation on the region to be processed to obtain an image frame to be processed.

In this implementation, in the process of beautifying the live streaming image frame, skin smoothing and whitening operations may be performed for users in the live streaming image frames. Due to the large size of live streaming image frames in VR live streaming scenarios, the computation amount of beautifying live streaming image frames is relatively high.

In order to improve the speed of beautification of the live streaming image frame, when performing the skin smoothing on the user in the live streaming image frame, it is only performed on the face and the exposed body part of the user in the live streaming image frame, but not performed on other parts in the live streaming image frame.

Therefore, after obtaining the live streaming image frame, the region to be processed in the live streaming image frame may first be recognized. Optionally, the region to be processed may be specifically a face of a user in the live streaming image frame, a exposed body part, or the like. Alternatively, in different application scenarios, if the request triggered by the user is an effect processing request for the target part, for example, if the request triggered by the user is an effect processing request for adding a sticker to the head, the region to be processed may be specifically a head of the user in the live streaming image frame.

After the region to be processed is recognized, the region to be processed may be performed with the first processing operation to obtain the image frame to be processed. When the image frame processing request is a beauty request, the first processing operation may be a skin smoothing on a region to be processed.

Step 204: performing a global second processing operation on the image frame to be processed to obtain a processed target image frame.

In this implementation, after the first processing operation on the region to be processed is completed, the global second processing operation may be performed on the image frame to be processed. When the image frame processing request is a beauty request, the second processing operation may be a whitening operation.

In practical applications, the image frame to be processed may comprise a background portion in addition to the user. When a global second processing operation is performed on the image frame to be processed, the user and the background portion need to be optimized at the same time. Therefore, in order to ensure the optimization effect of the second processing operation, a second color lookup table (lut image) corresponding to the live streaming image frame may be set in advance. Specifically, the lut image corresponding to the live streaming image frame may be adjusted. During the adjustment, a set of lut images that only affect the skin color and ensure that the background is not affected as much as possible is determined, and such lut image is used as the second color lookup table.

Further, a global color mapping operation may be performed on the image frame to be processed according to the first color lookup table, to complete a second processing operation on the image frame to be processed, to obtain a processed target image frame.

The global second processing operation on the image frame to be processed may specifically be image processing for the entire image frame to be processed.

Step 205: display the target image frame.

In this embodiment, after the optimization operation on the live streaming image frame is completed, the target image frame may be displayed.

Optionally, the target image frame may be sent to the predetermined terminal device for display. Thus, the user watches the 3D live streaming after beauty processing on the predetermined terminal device. Optionally, the predetermined terminal device may be specifically a virtual reality device.

Alternatively, after obtaining the target image frame, the predetermined display interface in the terminal device may be controlled to display the target image frame.

Further, on the basis of any of the above embodiments, step 202 comprises:
obtaining two image frames to be spliced that are captured by at least two cameras.
splicing the two image frames to be spliced to obtain the live streaming image frame.

In this embodiment, two image frames to be spliced that are captured by at least two cameras may be obtained, where an image size of each image frame to be spliced is 4K. In order to facilitate subsequent live streaming image frame optimization operations, the image frames to be spliced from two perspectives may be spliced left and right into a live streaming image frame of 8K. The spliced live streaming image frame of 8K is directly inputted into the terminal device for effect processing, and anti-distortion processing is not needed.

Optionally, the two cameras may be two cameras disposed on the binocular image capture device. Specifically, two image frames to be spliced that are captured by two cameras in the binocular image capture device may be obtained.

According to the method of processing a live streaming image frame provided in this embodiment, live streaming image frame corresponding to a virtual reality live streaming content is obtained based on the image frame processing request. A first processing operation is performed on a region to be processed in the live streaming image frame, and a global second processing operation is performed on the image frame to be processed after the first processing operation. The target image frame after the second processing operation is sent to the predetermined terminal device for display. Therefore, the image frame can be processed in the VR scene. In addition, by performing the first processing operation on the region to be processed and the second processing operation globally, it is possible to effectively reduce the computation in the image processing process, improve the efficiency of image beautification operations, and ensure high-quality live streaming effects.

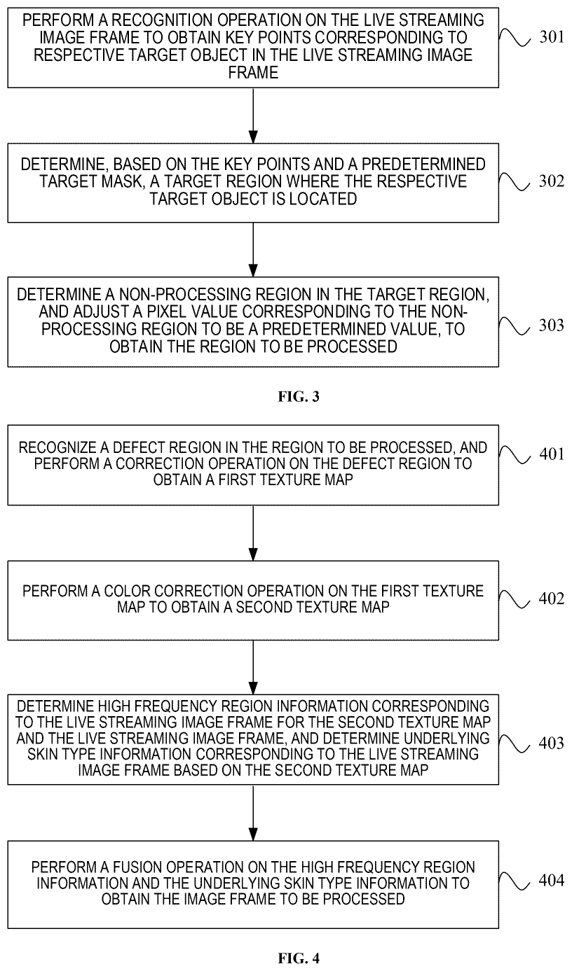

FIG. 3 is a schematic flowchart of a method of processing a live streaming image frame according to still another embodiment of the disclosure. On the basis of any of the foregoing embodiments, as shown in FIG. 3, step 203 comprises:

Step 301: performing a recognition operation on the live streaming image frame to obtain key points corresponding to respective target object in the live streaming image frame.

Step 302: determining, based on the key points and a predetermined target mask, a target region where the respective target object is located.

Step 303: determining a non-processing region in the target region, and adjusting a pixel value corresponding to the non-processing region to be a predetermined value, to obtain the region to be processed.

In this embodiment, after obtaining the live streaming image frame, the key points in the live streaming image frame may be recognized through a predetermined key point recognition algorithm to obtain the key points corresponding to the target objects in the live streaming image frame. It should be noted that since the inputted live streaming image frame is formed by splicing the image frames to be spliced at the left and right perspectives, if there are N target objects in the image frame to be spliced, the live streaming image frame will detect the face key points corresponding to the 2N target objects, and output the 2N sets of face key points.

Further, the target region where each target object is located may be determined according to the key points and a predetermined target mask. The target mask comprises a plurality of layers, and different layers respectively record eyebrow, nostril, and mouth and eye regions.

It can be understood that, in the first beautification operation, it is often necessary to act on the skin region of the user. Therefore, in order to improve the subsequent optimization effect and reduce the subsequent calculation amount, the non-processing region in the target region may be determined. Deleting the non-processing region to obtain the region to be processed. The non-processing region comprises, but is not limited to, positions of hair, eyes, eyebrows, and the like of the user.

Optionally, in order to implement the deletion of the non-processing region, the pixel value of the non-processing region may be adjusted, and the pixel value of the non-processing region is adjusted to a predetermined value to obtain the region to be processed.

According to the method of processing a live streaming image frame provided in this embodiment, the key points in the live streaming image frame are recognized, and the target region where the target object is located is determined according to the key points. Therefore, the first beautification operation can be performed based on the target region, which reduce the range of the first beautification operation, and reduce the calculation amount of beautification of the live streaming image frame.

Further, on the basis of any of the above embodiments, step 303 comprises:
converting the live streaming image frame from an RGB image to an HSV image, and determining a first non-processing region in the target region with a hue and a brightness of the HSV image being taken as constraint information.
determining a second non-processing region in the target region by adjusting a layer corresponding to the target mask.
setting pixel values corresponding to the first non-processing region and the second non-processing region in the target region to zero to obtain the region to be processed.

In this embodiment, in order to implement the deletion of the non-processing region, firstly, the live streaming image frame may be converted from the RGB image to the HSV image. HSV (Hue, Saturation, Value) is a color space created according to visual characteristics of colors. By taking the hue and the brightness of the HSV image as the constraint information, it is possible to screen out the first non-processing region which is different from the skin of the user. The first non-processing region comprises, but is not limited to, a non-skin region such as hair and glasses.

Further, the target mask may comprise a plurality of layers, and different layers respectively record eyebrows, nostrils, and a mouth and eyes region. By adjusting different layers of the target mask, the second non-processing region in the target region can be screened. The second non-processing region comprises, but is not limited to, eyes, nostrils, mouth, or the like.

After the first non-processing region and the second non-processing region are determined separately, the first non-processing region and the second non-processing region in the target region may be deleted to obtain the region to be processed including only the skin portion.

Optionally, the pixel values corresponding to the first non-processing region and the second non-processing region may be adjusted to zero, to implement the deletion of the first non-processing region and the second non-processing region.

According to the method of processing a live streaming image frame provided in this embodiment, the first non-processing region and the second non-processing region in the target region are deleted, which further reduce the range of the first beautification operation, effectively reduce the calculation amount of beautification of the live streaming image frame, improve the beautification efficiency of the live streaming image frame, and ensure he high-quality live streaming effect.

Further, on the basis of any of the above embodiments, step 203 comprises:
determining a face region in the live streaming image frame;
performing the first processing operation on at least one of a defect region, a shadow region, and a highlight region in the face region to obtain the image frame to be processed.

In this embodiment, the first processing operation may be specifically a processing operation on a face. Specifically, the face region in the live streaming image frame may be determined, where any face recognition manner may be used to recognize and extract the face region. A first processing operation is performed on at least one of a defect region, a shadow region, and a highlight region in the face region to obtain an image frame to be processed. The defect region may be a region where there is a spot and an acne, the highlight region may be an overexposure region, and the shadow region may be a region with a lower darkness.

By performing the whitening operation on the entire live streaming image frame, the face region is subjected to skin smoothing operation, so that the live streaming image frame can be effectively beautified, and then the live streaming effect of the virtual reality live streaming can be improved.

FIG. 4 is a schematic flowchart of a method of processing a live streaming image frame according to still another embodiment of the disclosure. On the basis of any of the above embodiments, as shown in FIG. 4, step 203 comprises:

Step 402: recognizing a defect region in the region to be processed, and performing a correction operation on the defect region to obtain a first texture map.

Step 402: performing a color correction operation on the first texture map to obtain a second texture map.

Step 403: determining high frequency region information corresponding to the live streaming image frame for the second texture map and the live streaming image frame, and determining underlying skin type information corresponding to the live streaming image frame based on the second texture map.

Step 404: fusing the high frequency region information and the underlying skin type information to obtain the image frame to be processed.

In this embodiment, the skin smoothing operation on the live streaming image frame may specifically comprise optimization of defect regions such as acne marks and correction operation on the whole skin. Therefore, after the region to be processed is obtained, the defect region in the region to be processed may be recognized first, and the defect region is corrected to obtain the first texture map.

Further, a color correction operation may be performed on the first texture map to achieve the purpose of brightening the skin curve and removing the yellow and red color to obtain the second texture map. For the second texture map, the high frequency region information corresponding to the live streaming image frame may be determined according to the second texture map and the live streaming image frame, and the underlying skin type information corresponding to the live streaming image frame may be determined according to the second texture map. After the layer is segmented, texture and details may be modified on the high frequency layer without destroying original color, and dark color blocks may be modified on the low frequency layer without damaging details. The high frequency region information and the underlying skin type information are fused to obtain an image frame to be processed.

According to the method of processing a live streaming image frame provided by the embodiment, the color is corrected by optimizing the defect region in the region to be processed, so that the optimization operation of the region to be processed can be effectively realized, and the beautification effect is achieved. In addition, by determining the high frequency region information corresponding to the live streaming image frame and the underlying skin type information corresponding to the live streaming image frame, after the layer is segmented, texture and detail can be modified on the high frequency layer without destroying original color, the dark color block can be modified on the low frequency layer without damaging details, and the optimization effect of the live streaming image frame is further improved.

Further, on the basis of any of the above embodiments, step 401 comprises:
blurring the region to be processed in the live streaming image frame by using a bilateral filtering algorithm to obtain a blurred image frame;
calculating a difference between the blurred image frame and the live streaming image frame;
in accordance with that the difference of any region is within a predetermined difference range, determining the region as a defect region.

In this embodiment, when the defect region is recognized, the region to be processed in the live streaming image frame may be first blurred. Specifically, the region to be processed in the live streaming image frame may be blurred by a bilateral filtering algorithm to obtain the blurred image frame. The viewport size of the bilateral filtering algorithm is (0.45*image height, 0.45*image width). The filter kernel size is 10 pixels.

The bilateral filtering is a nonlinear filter, which can achieve the effects of maintaining edge and smoothing noise. As with other filtering principles, bilateral filtering is also a weighted average method, the weighted average of the brightness values of the peripheral pixels represents the intensity of a certain pixel, and the weighted average used is based on a Gaussian distribution. The weight of bilateral filtering not only considers the Euclidean distance of the pixel, but also takes into account the difference in radiation in the pixel range domain (the similarity and color intensity between the pixel in the convolution kernel and the center pixel), and the two weights are considered at the same time when calculating the center pixel.

Further, a difference between the blurred image frame and the live streaming image frame may be calculated. In order to implement the recognition on the defect region, a difference range may be set in advance. For the difference between any region, if the difference falls within the difference range, it indicates that the region is a defect region.

Further, on the basis of any of the above embodiments, performing the correction operation on the defect region to obtain the first texture map comprises:
padding the defect region with a predetermined pixel average value to obtain the first texture map.

In this embodiment, since the defect region is generally a region with a higher pixel value or a region with lower pixel value, a pixel average value may be set in advance, and the pixel average value may be a pixel average value corresponding to a pixel in the live streaming image frame.

The defect region is padded with the pixel average value, and the defect region is optimized to obtain the first texture map.

According to the method of processing a live streaming image frame provided by the embodiment, the region to be processed is blurred, the difference between the blurred image frame and the live streaming image frame is calculated, so that the defect region in the region to be processed can be accurately positioned. Further, the defect region can be padded based on the predetermined pixel average value, the defect region is corrected, and the beautification effect of the live streaming image frame is ensured.

Further, on the basis of any of the above embodiments, step 402 comprises:
obtaining a predetermined color channel in the first texture map as a grayscale image corresponding to the first texture map, and obtaining a predetermined first color lookup table corresponding to the first texture map.
determining a target processing region in the grayscale image based on a predetermined grayscale value interval.
performing a color correction on the target processing region based on the first color lookup table to obtain the second texture map.

In this embodiment, for the first texture map, since the first texture map is an RGB image, the predetermined color channel in the first texture map may be used as the grayscale image corresponding to the first texture map. For example, the blue channel may be used as a grayscale image corresponding to the first texture map.

After obtaining the grayscale image corresponding to the first texture map, the brightness detail in the first texture map may be determined according to the grayscale image, and then the highlight region, the shadow region, and the like can be determined.

In practical applications, different images have different shadow characteristics. For example, in a live streaming image frame captured at a position with a higher brightness, an overexposure problem may occur. However, in a live streaming image frame captured at a position with a relatively low brightness, the problem of low definition due to dark may occur. Therefore, the shadow portion needs to be adjusted.

Therefore, for different application scenarios, a grayscale value interval may be predetermined. A target processing region in the grayscale image may be determined according to the grayscale value interval. A predetermined first color lookup table corresponding to the first texture map may be obtained. The first color lookup table can achieve the purpose of brightening the skin curve and removing the red and yellow color. The first color lookup table may be a lut image with a best optimization effect during adjustment. The process of determining the first color lookup table is not limited in the disclosure. Therefore, the color correction operation may be performed on the target processing region according to the first color lookup table to obtain the second texture map. Optionally, color mapping may be performed on the target processing region according to the first color lookup table to implement color correction.

According to the method of processing a live streaming image frame provided in this embodiment, the predetermined color channel in the first texture map is obtained as the grayscale image corresponding to the first texture map, and the target processing region in the grayscale image is determined according to the predetermined grayscale value range, so that the target optimization region may be accurately optimized, and the optimization effect is more personalized requirements of the user. In addition, the color correction operation is performed on the target processing region through the first color lookup table corresponding to the first texture map, so that the purpose of brightening the skin curve and removing the red and yellow color can be achieved, and the optimization effect of the live streaming image frame is improved.

Further, on the basis of any of the above embodiments, step 403 comprises:
performing a first joint bilateral filtering operation on the second texture map to obtain a first blurred result.
calculating a difference between the first blurred result and the live streaming image frame to obtain the high frequency region information.
performing a second joint bilateral filtering operation on the second texture map to obtain a second blurred result.
determining the second blurred result as the underlying skin type information corresponding to the live streaming image frame.
wherein a radius of a filtering kernel of the second joint bilateral filtering operation is greater than a radius of a filtering kernel of the first joint bilateral filtering operation.

In this embodiment, in order to further improve the optimization effect, after obtaining the second texture map, a first joint bilateral filtering operation may be performed on the second texture map to obtain a first blurred result. The first joint bilateral filtering operation may be a small-radius joint bilateral filtering processing. Further, a difference between the first blurred result and the live streaming image frame may be calculated to obtain the high frequency region information. A second joint bilateral filtering operation is performed on the second texture map to obtain a second blurred result. The second blurred result is determined as the underlying skin type information corresponding to the live streaming image frame. The second joint bilateral filtering operation may be a large-radius joint bilateral filtering processing. Optionally, a radius of the filtering kernel of the second joint bilateral filtering operation is greater than a radius of the filtering kernel of the first joint bilateral filtering operation. Preferably, the radius of the filtering kernel of the second joint bilateral filtering operation may be twice the radius of the filtering kernel of the first joint bilateral filtering operation.

Further, on the basis of any of the above embodiments, step 404 comprises:
performing a fusion operation on the high frequency region information and the underlying skin type information through a linear light mixing mode to obtain the image frame to be processed.

In this embodiment, a linear light mixing mode may be used to implement a fusion operation on the high frequency region information and the underlying skin type information to obtain the image frame to be processed.

Further, on the basis of any of the above embodiments, after step 404, the method further comprises:
sharpening the image frame to be processed to obtain a processed image frame to be processed.

The step 204 comprises:
performing a second processing operation on the processed image frame to be processed to obtain a processed target image frame.

In this embodiment, after obtaining the image frame to be processed, the image frame to be processed may further be sharpened to obtain the final skin smoothing result as the processed image frame to be processed. Further, a subsequent second processing operation may be performed according to the processed image frame to be processed to obtain a processed target image frame.

According to the method of processing a live streaming image frame provided by the embodiment, one picture is segmented into a high frequency layer and a low frequency layer, so that texture and detail can be modified on the high frequency layer without destroying original color, the dark color blocks can be modified on the low frequency layer without damaging details, and the effect of optimizing the live streaming image frame is improved.

FIG. 5 is a schematic flowchart of a method of processing a live streaming image frame according to still another embodiment of the disclosure. On the basis of any of the above embodiments, step 201 comprises:

Step 501: in response to a trigger performed by a user on a predetermined image processing control, displaying a predetermined image processing page, wherein the image processing page comprises at least one image processing item.

Step 502: in response to a selection of a user in the image processing page, obtaining the image frame processing request.

In this embodiment, the predetermined image processing control may be displayed in advance on the display interface. In response to a triggering performed by a user on a predetermined image processing control, a predetermined image processing page may be displayed by being redirected to, where the image processing page comprises at least one image processing item. Taking actual application for example, the image processing item may comprise at least a skin smoothing item, a whitening item, or the like.

After the image processing page is displayed, the user may select an image processing item that needs to be optimized currently according to actual requirements, and generate an image frame processing request based on the at least one image processing item selected by the user. Further, the image processing may be performed on the live streaming image frame in a targeted manner according to the image frame processing request.

For example, if the user selects the skin smoothing item and the whitening item, the skin smoothing processing may be performed locally and whitening processing may be performed globally on the live streaming image frame according to the image frame processing request.

Further, on the basis of any of the above embodiments, step 501 comprises:
displaying at least one predetermined image processing selection control, wherein the image processing selection control comprises a first image processing control and a second image processing control.
in response to a trigger performed by the user on the first image processing control, displaying a predetermined image processing page.
in response to a trigger performed by the user on the second image processing control, displaying a live streaming image frame corresponding to the virtual reality live streaming content.

In this embodiment, at least one image processing selection control may be displayed in advance on the display interface, where the image processing selection control comprises a first image processing control and a second image processing control. Taking the actual application for example, a selection box indicating whether to start the beautification may be displayed on the display interface, and the first image processing control and the second image processing control may be displayed in the selection box, where the first image processing control may be “yes”, and the second processing control may be “no”.

In response to the triggering performed by the user on the first image processing control, it is indicated that the user currently needs to perform the image processing operation. At this time, the predetermined image processing page may be displayed, so that the user selects, according to the actual requirement, the image processing item for optimization in the image processing page. On the contrary, in response to the trigger performed by the user on the second image processing control, it indicates that the user does not need to perform the image processing operation. At this time, the live streaming image frame corresponding to the virtual reality live streaming content may be directly sent to the display device for display, where the display device may be a virtual reality device.

According to the method of processing a live streaming image frame provided by the embodiment, the predetermined image processing page is displayed in response to the trigger of the user on the predetermined image processing control, so that the user can realize the determination of the processing item of the personalized live streaming image frame based on the image processing page, thus the display effect of the processed target image frame is more consistent with the actual requirement of the user, and the user experience is improved.

Further, on the basis of any of the above embodiments, step 502 comprises:
in response to a selection of the user on one or more image processing items in the image processing page, respectively determining an adjustment parameter corresponding to respective image processing item.
obtaining corresponding to the respective image processing item based on the adjustment parameter corresponding to the respective image processing item.

In this embodiment, for each image processing item, the user may further select an adjustment parameter corresponding to the image processing item. Optionally, the higher the adjustment parameter, the greater the intensity of the image processing, and vice versa, the lower the adjustment parameter, the lower the intensity of the image processing.

Therefore, after the image processing page is displayed, the adjustment parameter corresponding to respective image processing item may be determined separately in response to the selection of the user on one or more image processing items in the image processing page. Obtaining corresponding to the respective image processing item based on the adjustment parameter corresponding to the respective image processing item.

Optionally, the adjustment parameter may be determined by using a predetermined adjustment control, or the adjustment parameter may be determined by using a predetermined parameter input box, which is not limited in the disclosure.

By determining the adjustment parameter corresponding to respective image processing item, the image processing operation on the live streaming image frame can be more accurately realized.

Further, on the basis of any of the foregoing embodiments, each image processing item corresponds to at least one image processing sub-item and an adjustment control corresponding to respective image processing sub-item; and in response to the selection of the user on the one or more image processing items in the image processing page, respectively determining the adjustment parameter corresponding to the respective image processing item comprises:
in response to a trigger of the user on an adjustment control(s) corresponding to one or more image processing sub-items, obtaining an adjustment parameter(s) corresponding to the one or more image processing sub-items, and determining the adjustment parameter(s) corresponding to the one or more image processing sub-items as the adjustment parameter corresponding to the respective image processing item.

In this embodiment, each image processing item respectively corresponds to at least one image processing sub-item and an adjustment control corresponding to each image processing sub-item, and the user may determine the adjustment parameter by dragging the adjustment control.

Specifically, the adjustment parameter(s) corresponding to the one or more image processing sub-items may be obtained in response to a triggering performed by the user on the adjustment control corresponding to the one or more image processing sub-items, and the adjustment parameter(s) corresponding to the one or more image processing sub-items is determined as the adjustment parameter corresponding to each image processing sub-item.

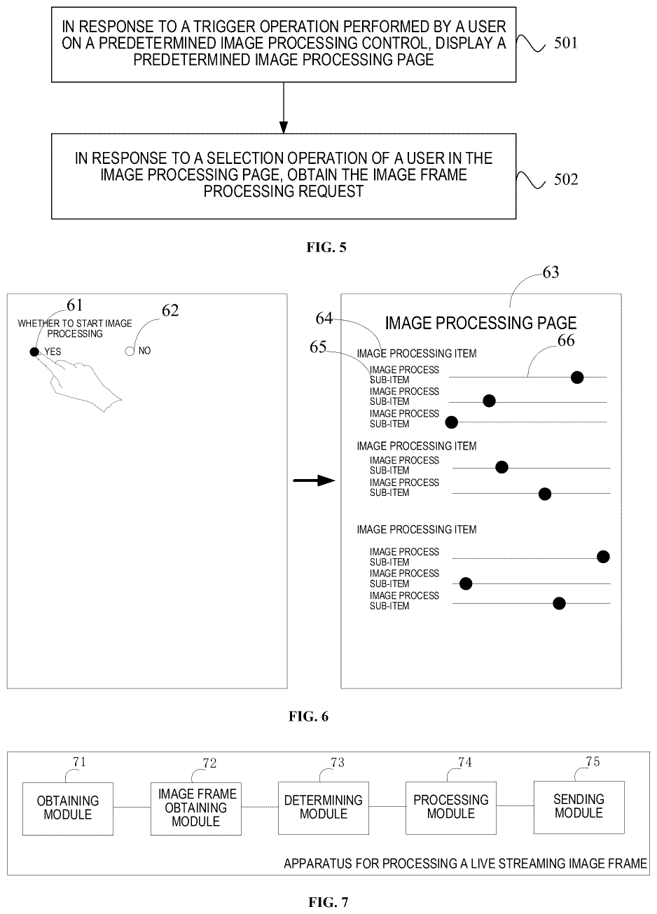

FIG. 6 is a schematic diagram of an interface interaction according to an embodiment of the disclosure. As shown in FIG. 6, the predetermined first image processing control 61 and second image processing control 62 may be displayed on the display interface. In response to the trigger of the user on the first image processing control 61, the image processing page 63 may be displayed. The image processing page 63 comprises multiple image processing items 64, each of which includes at least one image processing sub-item 65, and each image processing sub-item 65 corresponds to an adjustment control 66.

According to the method of processing a live streaming image frame provided in this embodiment, the adjustment control is set at the display position associated with each image processing sub-item, so that the user can quickly adjust and determine the adjustment parameter based on the adjustment control, thus the current image processing effect is more consistent with the personalized requirement of the user.

Further, on the basis of any of the above embodiments, the image processing item comprises at least a first processing item and a second processing item; after step 202, the following are further comprised:
If the image frame processing request comprises the first processing item and the second processing item, determining a region to be processed in the live streaming image frame, and performing a first processing operation on the region to be processed to obtain an image frame to be processed; and performing a global second processing operation on the image frame to be processed to obtain a processed target image frame;
If the image frame processing request comprises the first processing item, determining a region to be processed in the live streaming image frame, and performing a first processing operation on the region to be processed to obtain the target image frame;
If the image frame processing request comprises the second processing item, performing a global second processing operation on the live streaming image frame to obtain a processed target image frame.

In this embodiment, the image processing item comprises at least a first processing item and a second processing item. For example, the first processing item may be a skin smoothing item, and the second processing item may be a whitening item.

After obtaining the image frame processing request and the live streaming image frame, if it is detected that the image frame processing request comprises the first processing item and the second processing item, the region to be processed in the live streaming image frame may be determined, and the region to be processed is subjected to the first processing operation to obtain the image frame to be processed; and the image frame to be processed is subjected to the global second processing operation to obtain the processed target image frame. For example, if the image frame processing request comprises a skin smoothing item and a whitening item, a local skin smoothing operation and a global whitening operation may be performed on the live streaming image frame to obtain the target image frame.

If it is detected that the image frame processing request comprises the first processing item, the region to be processed in the live streaming image frame is determined, and the first processing operation is performed on the region to be processed to obtain the target image frame. For example, if the image frame processing request comprises a skin smoothing item, a local skin smoothing operation may be performed on the live streaming image frame to obtain the target image frame.

If it is detected that the image frame processing request comprises the second processing item, a global second processing operation is performed on the live streaming image frame to obtain a processed target image frame. For example, if the image frame processing request comprises a whitening item, a global whitening operation may be performed on the live streaming image frame to obtain the target image frame.

According to the method of processing a live streaming image frame provided by the embodiment, the corresponding live streaming image frame processing operation is carried out according to the live streaming image frame request generated by the selection of the user on the image processing project, so that the display effect of the virtual reality live streaming is more consistent with the personalized requirement of the user, and the live streaming effect is improved.

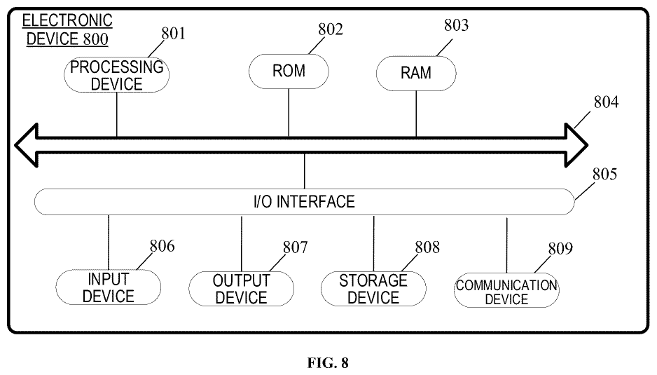

FIG. 7 is a schematic structure diagram of the apparatus for processing a live streaming image frame provided in the embodiment of the disclosure. As shown in FIG. 7, the apparatus comprises an obtaining module 71, an image frame obtaining module 72, a determining module 73, a processing module 74, and a sending module 75. The obtaining module 71 is configured to obtain an image frame processing request. The image frame obtaining module 72 is configured to obtain, based on the image frame processing request, a live streaming image frame corresponding to a virtual reality live streaming content. The determining module 73 is configured to determine a region to be processed in the live streaming image frame, and perform a first processing operation on the region to be processed to obtain an image frame to be processed. The processing module 74 is configured to perform a global second processing operation on the image frame to be processed to obtain a processed target image frame. The sending module 75 is configured to display the target image frame.

Further, on the basis of any of the foregoing embodiments, the image frame obtaining module is configured to: obtain two image frames to be spliced that are captured by at least two cameras; splice the two image frames to be spliced to obtain the live streaming image frame.

Further, on the basis of any of the foregoing embodiments, the determining module is configured to: recognize the live streaming image frame to obtain key points corresponding to respective target object in the live streaming image frame. Based on the key points and a predetermined target mask, a target region where the respective target object is located is determined. A non-processing region in the target region is determined, and a pixel value corresponding to the non-processing region is adjusted to be a predetermined value, to obtain the region to be processed.

Further, on the basis of any of the foregoing embodiments, the determining module is configured to: convert the live streaming image frame from an RGB image to an HSV image, and determine a first non-processing region in the target region with a hue and a brightness of the HSV image being taken as constraint information. A second non-processing region in the target region is determined by adjusting a layer corresponding to the target mask. The pixel values corresponding to the first non-processing region and the second non-processing region in the target region is set to zero to obtain the region to be processed.

Further, on the basis of any of the foregoing embodiments, the determining module is configured to: determine a face region in the live streaming image frame; perform the first processing operation on at least one of a defect region, a shadow region, and a highlight region in the face region to obtain the image frame to be processed.

Further, on the basis of any of the foregoing embodiments, the determining module is configured to: recognize a defect region in the region to be processed, and perform a correction operation on the defect region to obtain a first texture map. A color correction operation is performed on the first texture map to obtain a second texture map. The high frequency region information corresponding to the live streaming image frame is determined for the second texture map and the live streaming image frame, and underlying skin type information corresponding to the live streaming image frame is determined based on the second texture map. The high frequency region information and the underlying skin type information are fused to obtain the image frame to be processed.

Further, on the basis of any of the foregoing embodiments, the determining module is configured to: blur the region to be processed in the live streaming image frame by using a bilateral filtering algorithm to obtain a blurred image frame. A difference between the blurred image frame and the live streaming image frame are calculated. In accordance with that the difference of any region is within a predetermined difference range, the region is determined as a defect region.

Further, on the basis of any of the foregoing embodiments, the determining module is configured to: pad the defect region with a predetermined pixel average value to obtain the first texture map.

Further, on the basis of any of the foregoing embodiments, the determining module is configured to: obtain a predetermined color channel in the first texture map as a grayscale image corresponding to the first texture map, and obtain a predetermined first color lookup table corresponding to the first texture map. A target processing region in the grayscale image is determined based on a predetermined grayscale value interval. A color correction operation is performed on the target processing region based on the first color lookup table to obtain the second texture map.

Further, on the basis of any of the foregoing embodiments, the determining module is configured to: perform a first joint bilateral filtering operation on the second texture map to obtain a first blurred result. A difference between the first blurred result and the live streaming image frame is calculated to obtain the high frequency region information. A second joint bilateral filtering operation is performed on the second texture map to obtain a second blurred result. The second blurred result is determined as the underlying skin type information corresponding to the live streaming image frame. A radius of a filtering kernel of the second joint bilateral filtering operation is greater than a radius of a filtering kernel of the first joint bilateral filtering operation.

Further, on the basis of any of the foregoing embodiments, the determining module is configured to: fuse the high frequency region information and the underlying skin type information through a linear light mixing mode to obtain the image frame to be processed.

Further, on the basis of any of the foregoing embodiments, the apparatus further comprises: a sharpening module, configured to sharpen the image frame to be processed to obtain a processed image frame to be processed. The processing module is configured to: perform a global second processing operation on the processed image frame to be processed to obtain a processed target image frame.

Further, on the basis of any of the foregoing embodiments, the obtaining module is configured to: in response to a trigger performed by a user on a predetermined image processing control, display a predetermined image processing page, wherein the image processing page comprises at least one image processing item; in response to a selection of a user in the image processing page, obtain the image frame processing request.

Further, on the basis of any of the foregoing embodiments, the obtaining module is configured to: display at least one predetermined image processing selection control, wherein the image processing selection control comprises a first image processing control and a second image processing control; in response to a trigger performed by the user on the first image processing control, display a predetermined image processing page; in response to a trigger performed by the user on the second image processing control, display a live streaming image frame corresponding to the virtual reality live streaming content.

Further, on the basis of any of the foregoing embodiments, the obtaining module is configured to: in response to a selection of the user on one or more image processing items in the image processing page, respectively determine an adjustment parameter corresponding to respective image processing item; obtain corresponding to the respective image processing item based on the adjustment parameter corresponding to the respective image processing item.

Further, on the basis of any of the foregoing embodiments, each image processing item corresponds to at least one image processing sub-item and an adjustment control corresponding to respective image processing sub-item; and the obtaining module is configured to: in response to a trigger of the user on an adjustment control(s) corresponding to one or more image processing sub-items, obtain an adjustment parameter(s) corresponding to the one or more image processing sub-items, and determine the adjustment parameter(s) corresponding to the one or more image processing sub-items as the adjustment parameter corresponding to the respective image processing item.

Further, on the basis of any of the foregoing embodiments, the image processing item comprises at least a first processing item and a second processing item; the apparatus further comprises: a processing module, configured to: if the image frame processing request comprises the first processing item and the second processing item, determine a region to be processed in the live streaming image frame, and perform a first processing operation on the region to be processed to obtain an image frame to be processed; perform a global second processing operation on the image frame to be processed to obtain a processed target image frame; a processing module, configured to: if the image frame processing request comprises the first processing item, determine a region to be processed in the live streaming image frame, and perform a first processing operation on the region to be processed to obtain the target image frame; and a processing module, configured to: if the image frame processing request comprises the second processing item, perform a global second processing operation on the live streaming image frame to obtain a processed target image frame.

The device provided in this embodiment may be configured to perform the technical solutions in the foregoing method embodiments, and implementation principles and technical effects thereof are similar, and details are not repeated in this embodiment.

In order to implement the foregoing embodiments, an embodiment of the disclosure further provides an electronic device, comprising: a processor and a memory.

The memory stores computer-executable instructions.

The processor executes the computer-executable instructions stored in the memory, to cause the processor to execute the method of processing a live streaming image frame according to any of the above embodiments.

FIG. 8 is a schematic structural diagram of an electronic device according to an embodiment of the disclosure. The terminal device may include, but is not limited to, a mobile terminal such as a mobile phone, a notebook computer, a digital broadcast receiver, a personal digital assistant (PDA), a portable Android device (PAD), a portable media player (PMP), an on-board terminal (for example, an on-board navigation terminal), and a fixed terminal such as a digital TV, a desktop computer, or the like. The electronic device shown in FIG. 8 is merely an example, and should not impose any limitation on the functions and scope of use of the embodiments of the disclosure.

As shown in FIG. 8, the electronic device 800 may comprise a processing device (for example, a central processing unit, a graphics processor, etc.) 801, which may perform various appropriate actions and processing according to a program stored in a read only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. Input/output (I/O) interface 805 is also connected to bus 804.

Generally, the following devices may be connected to the I/O interface 805: an input device 806 comprising, for example, a touch screen, a touch pad, a keyboard, a mouse, a camera, a microphone, an accelerometer, a gyroscope, etc. ; an output device 807 comprising, for example, a liquid crystal display (LCD), a speaker, a vibrator, etc. ; a storage device 808 comprising, for example, a magnetic tape, a hard disk, etc. ; and a communication device 809. The communication device 809 may allow the electronic device 800 to communicate wirelessly or wired with other devices to exchange data. While FIG. 8 shows an electronic device 800 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure comprise a computer program product comprising a computer program embodied on a computer readable medium, the computer program comprising program code for performing the method shown in the flowchart. In such embodiments, the computer program may be downloaded and installed from the network through the communication device 809, or installed from the storage device 808, or from the ROM 802. When the computer program is executed by the processing apparatus 801, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may comprise, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may comprise a data signal propagated in baseband or as part of a carrier, where the computer readable program code is carried. Such propagated data signals may take a variety of forms comprising, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, comprising, but not limited to: wires, optical cables, RF (radio frequency), and the like, or any suitable combination of the foregoing.

An embodiment of the present disclosure further provides a computer-readable storage medium, where the computer-readable storage medium stores a computer-executable instruction, and when the processor executes the computer-executable instruction, the method of processing a live streaming image frame according to any of the foregoing embodiments is implemented.

An embodiment of the present disclosure further provides a computer program product, comprising a computer program, where the computer program, when executed by a processor, implements the method of displaying information according to any of the foregoing embodiments.

The computer-readable medium described above may be comprised in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, comprising object oriented programming languages, such as Java, Smalltalk, C ++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, comprising a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit for obtaining at least two Internet Protocol addresses”.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor systems, devices, or devices, or any suitable combination of the foregoing. More specific examples of machine-readable storage media may comprise electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In a first aspect, a method of processing a live streaming image frame is provided according to one or more embodiments of the disclosure, comprising:
obtaining an image frame processing request;
obtaining, based on the image frame processing request, a live streaming image frame corresponding to a virtual reality live streaming content;
determining a region to be processed in the live streaming image frame, and performing a first processing operation on the region to be processed to obtain an image frame to be processed;
performing a global second processing operation on the image frame to be processed to obtain a processed target image frame;
displaying the target image frame.

According to one or more embodiments of the disclosure, obtaining the live streaming image frame corresponding to the virtual reality live streaming content comprises:
obtaining two image frames to be spliced that are captured by at least two cameras;
splicing the two image frames to be spliced to obtain the live streaming image frame.

According to one or more embodiments of the disclosure, determining the region to be processed in the live streaming image frame comprises:
recognizing the live streaming image frame to obtain key points corresponding to respective target object in the live streaming image frame;
determining, based on the key points and a predetermined target mask, a target region where the respective target object is located;
determining a non-processing region in the target region, and adjusting a pixel value corresponding to the non-processing region to be a predetermined value, to obtain the region to be processed.

According to one or more embodiments of the disclosure, determining the non-processing region in the target region and adjusting the pixel value corresponding to the non-processing region to be the predetermined value comprises:
converting the live streaming image frame from an RGB image to an HSV image, and determining a first non-processing region in the target region with a hue and a brightness of the HSV image being taken as constraint information;
determining a second non-processing region in the target region by adjusting a layer corresponding to the target mask;
setting pixel values corresponding to the first non-processing region and the second non-processing region in the target region to zero to obtain the region to be processed.

According to one or more embodiments of the disclosure, determining the region to be processed in the live streaming image frame and performing the first processing operation on the region to be processed to obtain the image frame to be processed comprises:
determining a face region in the live streaming image frame;
performing the first processing operation on at least one of a defect region, a shadow region, and a highlight region in the face region to obtain the image frame to be processed.

According to one or more embodiments of the disclosure, performing the first processing operation on the region to be processed to obtain the image frame to be processed comprises:
recognizing a defect region in the region to be processed, and performing a correction operation on the defect region to obtain a first texture map;
performing a color correction operation on the first texture map to obtain a second texture map;
determining high frequency region information corresponding to the live streaming image frame for the second texture map and the live streaming image frame, and determining underlying skin type information corresponding to the live streaming image frame based on the second texture map;
fusing the high frequency region information and the underlying skin type information to obtain the image frame to be processed.

According to one or more embodiments of the disclosure, recognizing the defect region in the region to be processed comprises:
blurring the region to be processed in the live streaming image frame by using a bilateral filtering algorithm to obtain a blurred image frame;
calculating a difference between the blurred image frame and the live streaming image frame;
in accordance with that the difference of any region is within a predetermined difference range, determining the region as a defect region.

According to one or more embodiments of the disclosure, performing the correction operation on the defect region to obtain the first texture map comprises:
padding the defect region with a predetermined pixel average value to obtain the first texture map.

According to one or more embodiments of the disclosure, performing the color correction operation on the first texture map to obtain the second texture map comprises:
obtaining a predetermined color channel in the first texture map as a grayscale image corresponding to the first texture map, and obtaining a predetermined first color lookup table corresponding to the first texture map;
determining a target processing region in the grayscale image based on a predetermined grayscale value interval;
performing a color correction operation on the target processing region based on the first color lookup table to obtain the second texture map.

According to one or more embodiments of the disclosure, determining the high frequency region information corresponding to the live streaming image frame for the second texture map and the live streaming image frame and determining the underlying skin type information corresponding to the live streaming image frame based on the second texture map comprises:
performing a first joint bilateral filtering operation on the second texture map to obtain a first blurred result;
calculating a difference between the first blurred result and the live streaming image frame to obtain the high frequency region information;
performing a second joint bilateral filtering operation on the second texture map to obtain a second blurred result;
determining the second blurred result as the underlying skin type information corresponding to the live streaming image frame;
wherein a radius of a filtering kernel of the second joint bilateral filtering operation is greater than a radius of a filtering kernel of the first joint bilateral filtering operation.

According to one or more embodiments of the disclosure, fusing the high frequency region information and the underlying skin type information to obtain the image frame to be processed comprises:
fusing the high frequency region information and the underlying skin type information through a linear light mixing mode to obtain the image frame to be processed.

According to one or more embodiments of the disclosure, after fusing the high frequency region information and the underlying skin type information to obtain the image frame to be processed, further comprises:
sharpening the image frame to be processed to obtain a processed image frame to be processed;
perform a global second processing operation on the image frame to be processed to obtain a processed target image frame comprises:
perform a global second processing operation on the processed image frame to be processed to obtain a processed target image frame.

According to one or more embodiments of the disclosure, performing the global second processing operation on the image frame to be processed to obtain the processed target image frame comprises:
performing, based on a second color lookup table corresponding to the image frame to be processed, the global second processing operation on the image frame to be processed to obtain the processed target image frame.

According to one or more embodiments of the disclosure, obtaining the image frame processing request comprises:
in response to a trigger performed by a user on a predetermined image processing control, displaying a predetermined image processing page, wherein the image processing page comprises at least one image processing item;
in response to a selection of a user in the image processing page, obtaining the image frame processing request.

According to one or more embodiments of the disclosure, displaying the predetermined image processing page in response to the trigger performed by the user on a predetermined image processing control comprises:
displaying at least one predetermined image processing selection control, wherein the image processing selection control comprises a first image processing control and a second image processing control;
in response to a trigger performed by the user on the first image processing control, displaying a predetermined image processing page;
in response to a trigger performed by the user on the second image processing control, displaying a live streaming image frame corresponding to the virtual reality live streaming content.

According to one or more embodiments of the disclosure, obtaining the image frame processing request in response to the selection operation of the user in the image processing page comprises:
in response to a selection of the user on one or more image processing items in the image processing page, respectively determining an adjustment parameter corresponding to respective image processing item;
obtaining corresponding to the respective image processing item based on the adjustment parameter corresponding to the respective image processing item.

According to one or more embodiments of the disclosure, each image processing item corresponds to at least one image processing sub-item and an adjustment control corresponding to respective image processing sub-item; and in response to the selection operation of the user on the one or more image processing items in the image processing page, respectively determining the adjustment parameter corresponding to the respective image processing item comprises:
in response to a trigger of the user on an adjustment control(s) corresponding to one or more image processing sub-items, obtaining an adjustment parameter(s) corresponding to the one or more image processing sub-items, and determining the adjustment parameter(s) corresponding to the one or more image processing sub-items as the adjustment parameter corresponding to the respective image processing item.

According to one or more embodiments of the disclosure, the image processing item comprises at least a first processing item and a second processing item; obtaining the live streaming image frame corresponding to the virtual reality live streaming content further comprises:
if the image frame processing request comprises the first processing item and the second processing item, determining a region to be processed in the live streaming image frame, and perform a first processing operation on the region to be processed to obtain an image frame to be processed; performing a global second processing operation on the image frame to be processed to obtain a processed target image frame;
if the image frame processing request comprises the first processing item, determining a region to be processed in the live streaming image frame, and performing a first processing operation on the region to be processed to obtain the target image frame;
if the image frame processing request comprises the second processing item, performing a global second processing operation on the live streaming image frame to obtain a processed target image frame.

In a second aspect, according to one or more embodiments of the disclosure, a system for processing a live streaming image frame is provided, comprising: a terminal device, a binocular image capture device and a virtual reality device; wherein,
the binocular image capture device is configured to capture a live streaming image frame corresponding to a virtual reality live streaming content;
the terminal device is configured to obtain an image frame processing request, and obtain, based on the image frame processing request, a live streaming image frame corresponding to a virtual reality live streaming content; determine a region to be processed in the live streaming image frame, and perform a first processing operation on the region to be processed to obtain an image frame to be processed; perform a global second processing operation on the image frame to be processed to obtain a processed target image frame; and send the target image frame to the virtual reality device;
the virtual reality device is configured to display the target image frame.

In a third aspect, according to one or more embodiments of the disclosure, an apparatus for processing a live streaming image frame is provided, comprising:
an obtaining module, configured to obtain an image frame processing request;
an image frame obtaining module, configured to obtain, based on the image frame processing request, a live streaming image frame corresponding to a virtual reality live streaming content;
a determining module, configured to determine a region to be processed in the live streaming image frame, and perform a first processing operation on the region to be processed to obtain an image frame to be processed; and
a processing module, configured to perform a global second processing operation on the image frame to be processed to obtain a processed target image frame;
a sending module, configured to display the target image frame.

According to one or more embodiments of the disclosure, the image frame obtaining module is configured to:
obtain two image frames to be spliced that are captured by at least two cameras;
splice the two image frames to be spliced to obtain the live streaming image frame.

According to one or more embodiments of the disclosure, the determining module is configured to:
recognize the live streaming image frame to obtain key points corresponding to respective target object in the live streaming image frame;
determine, based on the key points and a predetermined target mask, a target region where the respective target object is located;
determine a non-processing region in the target region, and adjusting a pixel value corresponding to the non-processing region to be a predetermined value, to obtain the region to be processed.

According to one or more embodiments of the disclosure, the determining module is configured to:
convert the live streaming image frame from an RGB image to an HSV image, and determine a first non-processing region in the target region with a hue and a brightness of the HSV image being taken as constraint information;
determine a second non-processing region in the target region by adjusting a layer corresponding to the target mask;
set pixel values corresponding to the first non-processing region and the second non-processing region in the target region to zero to obtain the region to be processed.

According to one or more embodiments of the disclosure, the determining module is configured to:
determine a face region in the live streaming image frame;
perform the first processing operation on at least one of a defect region, a shadow region, and a highlight region in the face region to obtain the image frame to be processed.

According to one or more embodiments of the disclosure, the determining module is configured to:
recognize a defect region in the region to be processed, and performing a correction operation on the defect region to obtain a first texture map;
perform a color correction operation on the first texture map to obtain a second texture map;
determine high frequency region information corresponding to the live streaming image frame for the second texture map and the live streaming image frame, and determining underlying skin type information corresponding to the live streaming image frame based on the second texture map;
fuse the high frequency region information and the underlying skin type information to obtain the image frame to be processed.

According to one or more embodiments of the disclosure, the determining module is configured to:
blur the region to be processed in the live streaming image frame by using a bilateral filtering algorithm to obtain a blurred image frame;
calculate a difference between the blurred image frame and the live streaming image frame;
in accordance with that the difference of any region is within a predetermined difference range, determine the region as a defect region.

According to one or more embodiments of the disclosure, the determining module is configured to:
pad the defect region with a predetermined pixel average value to obtain the first texture map.

According to one or more embodiments of the disclosure, the determining module is configured to:
obtain a predetermined color channel in the first texture map as a grayscale image corresponding to the first texture map, and obtain a predetermined first color lookup table corresponding to the first texture map;
determine a target processing region in the grayscale image based on a predetermined grayscale value interval;
perform a color correction operation on the target processing region based on the first color lookup table to obtain the second texture map.

According to one or more embodiments of the disclosure, the determining module is configured to:
perform a first joint bilateral filtering operation on the second texture map to obtain a first blurred result;
calculate a difference between the first blurred result and the live streaming image frame to obtain the high frequency region information;
perform a second joint bilateral filtering operation on the second texture map to obtain a second blurred result;
determine the second blurred result as the underlying skin type information corresponding to the live streaming image frame;
wherein a radius of a filtering kernel of the second joint bilateral filtering operation is greater than a radius of a filtering kernel of the first joint bilateral filtering operation.

According to one or more embodiments of the disclosure, the determining module is configured to:
fuse the high frequency region information and the underlying skin type information through a linear light mixing mode to obtain the image frame to be processed.

According to one or more embodiments of the disclosure, the apparatus further comprises:
a sharpening module, configured to sharpen the image frame to be processed to obtain a processed image frame to be processed;
the determining module is configured to:
perform a global second processing operation on the processed image frame to be processed to obtain a processed target image frame.

According to one or more embodiments of the disclosure, the determining module is configured to: perform, based on a second color lookup table corresponding to the image frame to be processed, the global second processing operation on the image frame to be processed to obtain the processed target image frame.

According to one or more embodiments of the disclosure, the obtaining module is configured to:
in response to a trigger performed by a user on a predetermined image processing control, display a predetermined image processing page, wherein the image processing page comprises at least one image processing item;
in response to a selection of a user in the image processing page, obtain the image frame processing request.

According to one or more embodiments of the disclosure, the obtaining module is configured to:
display at least one predetermined image processing selection control, wherein the image processing selection control comprises a first image processing control and a second image processing control;
in response to a trigger performed by the user on the first image processing control, displaying a predetermined image processing page;
in response to a trigger performed by the user on the second image processing control, display a live streaming image frame corresponding to the virtual reality live streaming content.

According to one or more embodiments of the disclosure, the obtaining module is configured to:
in response to a selection of the user on one or more image processing items in the image processing page, respectively determine an adjustment parameter corresponding to respective image processing item;
obtain corresponding to the respective image processing item based on the adjustment parameter corresponding to the respective image processing item.

According to one or more embodiments of the disclosure, each image processing item corresponds to at least one image processing sub-item and an adjustment control corresponding to respective image processing sub-item; and the obtaining module is configured to:
in response to a trigger of the user on an adjustment control(s) corresponding to one or more image processing sub-items, obtain an adjustment parameter(s) corresponding to the one or more image processing sub-items, and determine the adjustment parameter(s) corresponding to the one or more image processing sub-items as the adjustment parameter corresponding to the respective image processing item.

According to one or more embodiments of the disclosure, the image processing item comprises at least a first processing item and a second processing item; the apparatus further comprises:
a processing module, configured to, if the image frame processing request comprises the first processing item and the second processing item, determine a region to be processed in the live streaming image frame, and perform a first processing operation on the region to be processed to obtain an image frame to be processed; perform a global second processing operation on the image frame to be processed to obtain a processed target image frame;
the processing module configured to, if the image frame processing request comprises the first processing item, determine a region to be processed in the live streaming image frame, and performing a first processing operation on the region to be processed to obtain the target image frame;
the processing module configured to, if the image frame processing request comprises the second processing item, perform a global second processing operation on the live streaming image frame to obtain a processed target image frame.

In a fourth aspect, according to one or more embodiments of the disclosure, an electronic device is provided, comprising: a processor and a memory;
the memory storing computer executable instructions;
the processor executing the computer-executable instructions stored in the memory, to cause the processor to implement a method of processing a live streaming image frame according to the above first aspect and various possible designs thereof.

In a fifth aspect, according to one or more embodiments of the disclosure, a computer-readable storage medium is provided. The computer-readable storage medium storing computer-executable instructions which, when executed by a processor, implements a method of processing a live streaming image frame according to the above first aspect and various possible designs thereof.

In a sixth aspect, according to one or more embodiments of the disclosure, a computer program product is provided, comprising a computer program, the computer program, when executed by a processor, implementing a method of processing a live streaming image frame according to the above first aspect and various possible designs thereof.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in a plurality of embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely example forms of realizing the claims.

1. A method of processing a live streaming image frame, comprising:
obtaining an image frame processing request;
obtaining, based on the image frame processing request, a live streaming image frame corresponding to a virtual reality live streaming content;
determining a region to be processed in the live streaming image frame, and performing a first processing operation on the region to be processed to obtain an image frame to be processed;
performing a global second processing operation on the image frame to be processed to obtain a processed target image frame; and
displaying the target image frame.

2. The method of claim 1, wherein obtaining the live streaming image frame corresponding to the virtual reality live streaming content comprises:
obtaining two image frames to be spliced that are captured by at least two cameras; and
splicing the two image frames to be spliced to obtain the live streaming image frame.

3. The method of claim 1, wherein determining the region to be processed in the live streaming image frame comprises:
recognizing the live streaming image frame to obtain key points corresponding to respective target object in the live streaming image frame;
determining, based on the key points and a predetermined target mask, a target region where the respective target object is located; and
determining a non-processing region in the target region, and adjusting a pixel value corresponding to the non-processing region to be a predetermined value, to obtain the region to be processed.

4. The method of claim 3, wherein determining the non-processing region in the target region and adjusting the pixel value corresponding to the non-processing region to be the predetermined value comprises:
converting the live streaming image frame from an RGB image to an HSV image, and determining a first non-processing region in the target region with a hue and a brightness of the HSV image being taken as constraint information;
determining a second non-processing region in the target region by adjusting a layer corresponding to the target mask; and
setting pixel values corresponding to the first non-processing region and the second non-processing region in the target region to zero to obtain the region to be processed.

5. The method of claim 1, wherein determining the region to be processed in the live streaming image frame and performing the first processing operation on the region to be processed to obtain the image frame to be processed comprises:
determining a face region in the live streaming image frame; and
performing the first processing operation on at least one of a defect region, a shadow region, and a highlight region in the face region to obtain the image frame to be processed.

6. The method of claim 1, wherein the region to be processed is a face region; and performing the first processing operation on the region to be processed to obtain the image frame to be processed comprises:
recognizing a defect region in the region to be processed, and performing a correction operation on the defect region to obtain a first texture map;
performing a color correction operation on the first texture map to obtain a second texture map;
determining high frequency region information corresponding to the live streaming image frame for the second texture map and the live streaming image frame, and determining underlying skin type information corresponding to the live streaming image frame based on the second texture map; and
fusing the high frequency region information and the underlying skin type information to obtain the image frame to be processed.

7. The method of claim 6, wherein recognizing the defect region in the region to be processed comprises:
blurring the region to be processed in the live streaming image frame by using a bilateral filtering algorithm to obtain a blurred image frame;
calculating a difference between the blurred image frame and the live streaming image frame; and
in accordance with that the difference of any region is within a predetermined difference range, determining the region as a defect region.

8. The method of claim 6, wherein performing the correction operation on the defect region to obtain the first texture map comprises:
padding the defect region with a predetermined pixel average value to obtain the first texture map.

9. The method of claim 6, wherein performing the color correction operation on the first texture map to obtain the second texture map comprises:
obtaining a predetermined color channel in the first texture map as a grayscale image corresponding to the first texture map, and obtaining a predetermined first color lookup table corresponding to the first texture map;
determining a target processing region in the grayscale image based on a predetermined grayscale value interval; and
performing a color correction operation on the target processing region based on the first color lookup table to obtain the second texture map.

10. The method of claim 6, wherein determining the high frequency region information corresponding to the live streaming image frame for the second texture map and the live streaming image frame and determining the underlying skin type information corresponding to the live streaming image frame based on the second texture map comprises:
performing a first joint bilateral filtering operation on the second texture map to obtain a first blurred result;
calculating a difference between the first blurred result and the live streaming image frame to obtain the high frequency region information;
performing a second joint bilateral filtering operation on the second texture map to obtain a second blurred result; and
determining the second blurred result as the underlying skin type information corresponding to the live streaming image frame;
wherein a radius of a filtering kernel of the second joint bilateral filtering operation is greater than a radius of a filtering kernel of the first joint bilateral filtering operation.

11. The method of 1-4claim 1, wherein performing the global second processing operation on the image frame to be processed to obtain the processed target image frame comprises:
performing, based on a second color lookup table corresponding to the image frame to be processed, the global second processing operation on the image frame to be processed to obtain the processed target image frame.

12. The method of claim 1, wherein obtaining the image frame processing request comprises:
in response to a trigger performed by a user on a predetermined image processing control, displaying a predetermined image processing page, wherein the image processing page comprises at least one image processing item;
in response to a selection of a user in the image processing page, obtaining the image frame processing request.

13. The method of claim 12, wherein displaying the predetermined image processing page in response to the trigger performed by the user on a predetermined image processing control comprises:
displaying at least one predetermined image processing selection control, wherein the image processing selection control comprises a first image processing control and a second image processing control;
in response to a trigger performed by the user on the first image processing control, displaying a predetermined image processing page;
in response to a trigger performed by the user on the second image processing control, displaying a live streaming image frame corresponding to the virtual reality live streaming content.

14. The method of claim 12, wherein obtaining the image frame processing request in response to the selection of the user in the image processing page comprises:
in response to a selection of the user on one or more image processing items in the image processing page, respectively determining an adjustment parameter corresponding to respective image processing item; and
obtaining the image frame processing request corresponding to the respective image processing item based on the adjustment parameter corresponding to the respective image processing item.

15. The method of claim 14, wherein each image processing item corresponds to at least one image processing sub-item and an adjustment control corresponding to respective image processing sub-item; and in the one respectively determining the adjustment parameter corresponding to the respective image processing item comprises:
in response to a trigger of the user on one or more adjustment controls corresponding to one or more image processing sub-items, obtaining one or more adjustment parameters corresponding to the one or more image processing sub-items, and determining the one or more adjustment parameters corresponding to the one or more image processing sub-items as the adjustment parameter corresponding to the respective image processing item.

16-17. (canceled)

18. An electronic device, comprising: a processor and a memory;
the memory storing computer executable instructions; and
the processor executing the computer-executable instructions stored in the memory, to cause the processor to implement acts comprising:
obtaining an image frame processing request;
obtaining, based on the image frame processing request, a live streaming image frame corresponding to a virtual reality live streaming content;
determining a region to be processed in the live streaming image frame, and performing a first processing operation on the region to be processed to obtain an image frame to be processed;
performing a global second processing operation on the image frame to be processed to obtain a processed target image frame; and
displaying the target image frame.

19-20. (canceled)

21. The electronic device of claim 18, wherein determining the region to be processed in the live streaming image frame comprises:
recognizing the live streaming image frame to obtain key points corresponding to respective target object in the live streaming image frame;
determining, based on the key points and a predetermined target mask, a target region where the respective target object is located; and
determining a non-processing region in the target region, and adjusting a pixel value corresponding to the non-processing region to be a predetermined value, to obtain the region to be processed.

22. The electronic device of claim 21, wherein determining the non-processing region in the target region and adjusting the pixel value corresponding to the non-processing region to be the predetermined value comprises:
converting the live streaming image frame from an RGB image to an HSV image, and determining a first non-processing region in the target region with a hue and a brightness of the HSV image being taken as constraint information;
determining a second non-processing region in the target region by adjusting a layer corresponding to the target mask; and
setting pixel values corresponding to the first non-processing region and the second non-processing region in the target region to zero to obtain the region to be processed.

23. The electronic device of claim 18, wherein determining the region to be processed in the live streaming image frame and performing the first processing operation on the region to be processed to obtain the image frame to be processed comprises:
determining a face region in the live streaming image frame; and
performing the first processing operation on at least one of a defect region, a shadow region, and a highlight region in the face region to obtain the image frame to be processed.

24. A non-transitory computer-readable storage medium, the computer-readable storage medium storing computer-executable instructions which, when executed by a processor, implements a method comprising:
obtaining an image frame processing request;
obtaining, based on the image frame processing request, a live streaming image frame corresponding to a virtual reality live streaming content;
determining a region to be processed in the live streaming image frame, and performing a first processing operation on the region to be processed to obtain an image frame to be processed;
performing a global second processing operation on the image frame to be processed to obtain a processed target image frame;
displaying the target image frame.
